(19) United States
(12) Patent Application Publication
(10) Pub. No.: US 2019/0276129 A1
(43) Pub. Date: Sep. 12, 2019

(54) MODULAR PAYLOAD AIRFRAME SECTION

(71) Applicant: MONO AEROSPACE IP LTD, London (GB)

(72) Inventor: Brian Morgan, London (GB)

(21) Appl. No.: 16/345,237

(22) PCT Filed: Oct. 27, 2017
(86) PCT No.: PCT/GB2017/053248

§ 371 Date: Apr. 25, 2019

(30) Foreign Application Priority Data
Oct. 27, 2016 (GB) 1618201.6

(51) Int. Cl. B64C 1/06; B64C 39/02; B64C 29/00

(52) U.S. Cl. CPC B64C 1/069; B64C 39/024; B64C 29/0008; B64C 2211/00; B64C 2201/123; B64C 2201/088; B64C 2201/126; B64C 2201/127; B64C 2201/021

(57) ABSTRACT

A modular payload airframe section for an aircraft airframe is disclosed. The modular payload airframe section comprises: a storage volume for receiving a payload; a releasable fixation means for releasably affixing the modular payload airframe section to an airframe of the aircraft; and wherein the modular payload airframe section forms at least part of a nose-cone of the aircraft airframe when affixed thereto.

### FIELD OF THE INVENTION

The present invention relates to the field of aeronautics and in particular relates to removable modular airframe section for an aircraft airframe. The removable modular airframe section may be removably attached to the aircraft airframe. The modules of the present invention are particularly useful for use with high-speed fixed-wing vertical take-off and landing (VTOL) type aircraft configurations. Aspects of the invention relate to a modular payload airframe section for an aircraft airframe; to an aircraft comprising a modular payload airframe section; to an aircraft fuselage configured to receive the modular payload airframe section; and to a method of forming an airframe of an aircraft.

### BACKGROUND OF THE INVENTION

Modular aircraft systems designs are known in the art. Most of the known art focuses on internal structural concerns as it pertains to cargo type changes.

U.S. Pat. No. 8,292,220 (Westra) discusses the design of a modular flying wing type aircraft where the center fuselage section is adaptable to accommodate multiple compartment systems.

Another, somewhat similar solution is disclosed in U.S. Pat. No. 5,975,464 (Rutan), which describes an aircraft design that incorporates a central removable payload module that forms a structural link between a forward fuselage segment and an aft fuselage segment.

A disadvantage of the removable modules of the known prior art, is that due to their incorporation in the aircraft fuselage, they contribute a significant function in the structural integrity of the aircraft. This in turn often reduces the available storage volume, since an increasing portion of the module needs to be dedicated to satisfying the structural requirements demanded of the specific airframe fuselage section in which the module is being fitted. A further disadvantage of the removable modules disclosed in the prior art is that because the modules are incorporated into the fuselage of the aircraft, this increases the complexity and time required to interchange modules. In practice, this makes it inconvenient to exchange modules on-site, where in effect significant aircraft disassembly is required to interchange or otherwise change a fitted payload module.

It is an object of the present invention to address at least some of the aforementioned shortcomings associated with the prior art.

### SUMMARY OF THE INVENTION

An aspect of the invention relates to a modular payload airframe section for an aircraft airframe. The modular payload airframe section comprises a storage volume for receiving a payload, and a releasable fixation means for releasably affixing the modular payload airframe section to an airframe of the aircraft. When affixed to the aircraft airframe, the modular payload airframe section forms at least part of a nose-cone of the aircraft airframe. An advantage associated with this aspect of the invention is that the modular payload airframe section forms part of the aircraft airframe, and can be easily removed and interchanged with different types of modular payload airframe sections configured with different functionality. In this way, a single aircraft airframe may be re-deployed on a plurality of different missions. Depending on the mission requirements, different modular payload airframe sections configured with the required mission functionality may be affixed to the aircraft airframe. In this way, the modular payload airframe section enables improved aircraft mission flexibility. The modular payload airframe section may be affixed to any type of aircraft airframe. For example, the aircraft airframe may relate to the airframe of a high disk loaded fixed-wing VTOL aircraft. The aircraft may be manned or unmanned.

In certain embodiments the releasable fixation means may comprise one or more male members arranged for engagement with one or more female members comprised in the airframe of the aircraft. The releasable fixation means enables the modular payload airframe section to be easily removed from the aircraft airframe, improving the on-site mission flexibility of aircraft configured with the current modular payload airframe section.

Optionally, the modular payload airframe section may comprise one or more alignment pin cavities, each cavity being arranged to receive an alignment pin comprised in the aircraft airframe, to facilitate alignment of the modular payload airframe with the aircraft airframe when affixing the modular payload airframe section to the aircraft airframe.

In certain embodiments the modular payload airframe section may comprise a hollow nose-cone. The storage volume may be formed at least partly within the hollow nose-cone. In this way, advantageously, the modular payload airframe section defines the nose-cone of the resulting aircraft and contributes to the aerodynamic performance of the aircraft. The modular payload airframe section may be configured to taper to an apex at a first end to define the nose-cone, and may be configured with the releasable fixation means at a second end located opposite the first end. An advantage associated with this feature is that the modular payload airframe is only affixed to the aircraft frame at one end, which greatly facilitates and improves the convenience of interchanging modular payload airframe sections.

Optionally, the modular payload airframe section comprises a projection extending axially from the second end and forms a stepped profile with the nose-cone when viewed in a plane extending parallel to a lengthwise axis of the nose-cone. In use, the projection may be arranged to form a lap joint with a complementary shaped projection extending from a fuselage section of the aircraft airframe. The stepped profile defines three contact surfaces for engagement with the complementary shaped projection extending from the fuselage section of the aircraft airframe. Advantageously, the lap joint configuration improves the distribution of stress at the junction between the modular payload airframe section and the aircraft airframe, and results in a more robust junction between the modular payload airframe section and the aircraft fuselage.

Optionally, the projection comprises at least one of the one or more alignment pin cavities. This helps to improve the ease of alignment whist affixing the modular payload airframe structure to the aircraft airframe.

In certain embodiments, the modular payload airframe section is dimensioned to form an aerodynamically smooth junction with the aircraft airframe when affixed thereto. This reduces parasitic draft and improves the overall aerodynamic performance of the aircraft.

In certain embodiments the modular payload airframe section comprises a fuel tank engageable with a fuel system of the aircraft airframe. This provides a convenient way of increasing an aircraft's fuel tank and hence flight range.

Optionally, the modular payload airframe may comprise a refueling wand affixed to the exterior of the modular payload airframe section. This enables the modular payload airframe to be used for in-flight refueling.

In certain embodiments, the modular payload airframe section may comprise a Disaster Relief Module for Medical Transport (DRA-M), enabling the modular payload airframe to be used for medical evacuation purposes.

In certain embodiments, the modular payload airframe section may comprise surveillance equipment. This enables the modular payload airframe section to be used for surveillance missions.

In certain embodiments, the modular payload airframe section may comprise one or more image capture devices, providing image capture functionality. Optionally, the image capture device may be configured to image any one or more of the following types of electromagnetic radiation: infrared; ultraviolet; x-rays; and microwaves.

In certain embodiments, the modular payload airframe section may comprise an aerial relay station. This enables the modular payload airframe to provide a signal relay functionality, and enables the range of a base signal to be greatly increased. This functionality is particularly useful for use in swarms or other missions involving multiple different aircrafts, in which it may be essential to increase the range of a base signal.

In certain embodiments, the modular payload airframe section may comprise a radar module.

In certain embodiments, the modular payload airframe section may comprise a LIDAR module.

In certain embodiments, the modular payload airframe section may comprise a chemical dispenser module configured to spray the chemical on underlying terrain in use. This is particular useful for agricultural uses.

In certain embodiments, the chemical may be any one of a fertilizer and a de-icer. The use of a de-icer is particularly advantageous, for example, for use in weatherproofing aircraft and/or airports in adverse weather conditions

In certain embodiments, the modular payload airframe section may comprise a cockpit arranged to accommodate a pilot. In this way, it is possible for different pilots to have different anatomically customised cockpits, and to exchange between different modular payload airframe sections as required.

In certain embodiments, the modular payload airframe section may be configured for use with a vertical take-off and landing (VTOL) aircraft frame. Optionally, the VTOL airframe may be the airframe of an unmanned aerial vehicle (UAV).

A further aspect of the invention relates to an aircraft comprising the aforementioned modular payload airframe section, and such an aircraft also shares the same aforementioned advantages.

In certain embodiments the aircraft may relate to a VTOL aircraft.

Optionally, the VTOL aircraft may comprise two or more pairs of lift rotors, and one or more axial thrusters.

Optionally, the VTOL aircraft may relate to a UAV.

A further aspect of the invention relates to an aircraft fuselage configured to receive the aforementioned modular payload airframe section, and benefits from the same advantages associated with the aforementioned modular payload airframe section. Optionally the aircraft fuselage may relate to a VTOL aircraft fuselage.

Yet a further aspect of the invention relates to a method of forming an airframe of an aircraft. The method comprises: providing a main fuselage section representing a portion of an aircraft fuselage; providing a modular payload airframe section having a storage volume for receiving a payload; bringing the main fuselage section and the modular payload airframe section together at a mutual interface; and releasably locking the two sections securely, such that the modular payload airframe section forms at least part of a nose-cone of the aircraft airframe.

Further advantages associated with aspects of the invention are enhanced on-site mission flexibility, and reduced operations and acquisition costs, when compared to a traditional fleet of aircraft comprising a plurality of special purpose aircraft, each aircraft configured with specific functionality. Instead, aspects of the present invention enable a single aircraft airframe to be employed to carry out a plurality of different mission types, simply by exchanging the modular payload airframe section with the payload section having the functionality required for the specific mission at hand.

### BRIEF DESCRIPTION OF DRAWINGS

One or more embodiments of the invention will now be described, by way of non-limiting example only, with reference to the accompanying drawings, in which:

FIG. 1 is an isometric view of an exemplary modular payload section mounted to an example airframe (shown dash-lined), in accordance with an embodiment of the invention;

FIG. 2 is a top view of the modular payload section mounted to the example airframe of FIG. 1;

FIG. 3 is a side view of the modular payload section mounted to the example airframe of FIGS. 1 and 2;

FIGS. 4 through 9 are side views of alternative exemplary payload modules, each exemplary payload being configured to provide a different functionality, and each mounted to the airframe of FIG. 1, wherein:

FIG. 4 depicts an extended range Intelligence, Surveillance and Reconnaissance (ISR) or geographical survey payload module;

FIG. 5 depicts a communications array station/relay payload module section;

FIG. 6 depicts a multiple bay supply delivery payload module section;

FIG. 7 depicts a filming payload module section for professional high-speed filming;

FIG. 8 depicts a stretcher transport payload module section for use in trauma, medivac, and DRA scenarios; and

FIG. 9 depicts a fuel range extending/transport/refueling payload module section;

FIG. 10a is a side view of an exemplary payload module depicting the mating faces;

FIG. 10b is a perspective view of the exemplary payload module of FIG. 10a;

FIG. 11 is a top view of a portion of the airframe of FIG. 1, depicting alignment pins configured to engage with a modular payload section;

FIG. 12 is a side view of the alignment pins of FIG. 11;

FIG. 13 is an isometric perspective view of the alignment pins of FIG. 11, and also shows a latch pin retaining pocket, the alignment pins and latch pin retaining pocket are not shown to scale and are disproportionately sized for clarity purposes only;

FIG. 14 is a plan view of an exemplary latch assembly adopted in embodiments of the invention, in it's ready to engage position;

FIG. 15 is a plan view of the exemplary latch assembly of FIG. 14, in its first stage of engagement (first 90 degrees of clockwise rotation) position;

FIG. 16 is a plan view of the exemplary latch assembly of FIGS. 14 and 15, shown in its engaged position, in which the latch handle itself is pressed into its respective flight position pocket; and

FIG. 17 is a plan view of an exemplary VTOL aircraft comprising the modular payload section of FIG. 1.

### DETAILED DESCRIPTION

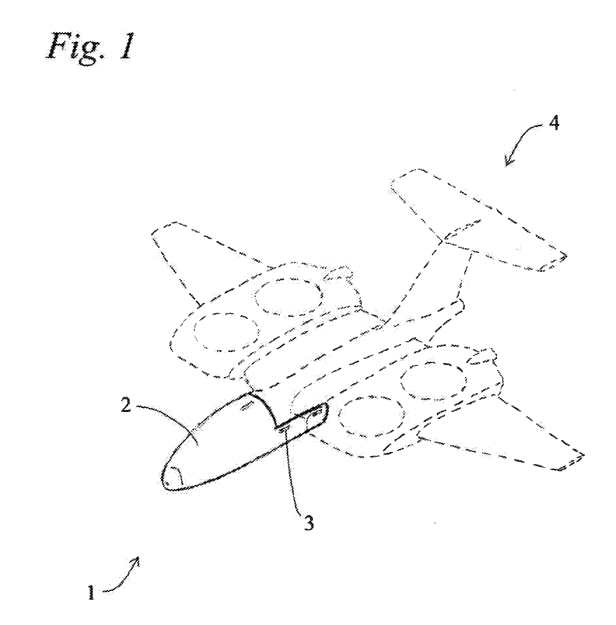

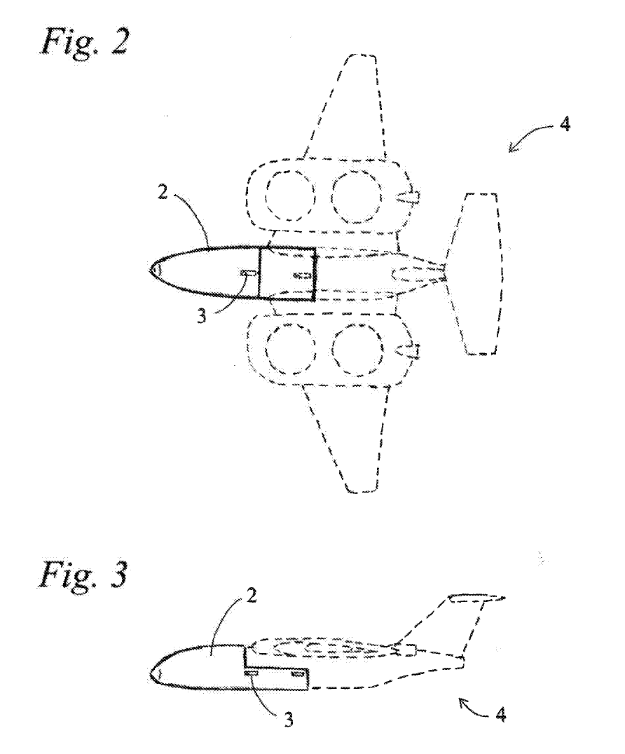

A modular payload airframe section 1 is shown in FIG. 1, comprising a main payload fuselage section 2, comprising a releasable fixation means for releasably affixing the payload airframe section to a VTOL airframe 4. The fixation means may comprise a multi-point locking mechanism system 3, which is dimensioned according to connecting surface areas matched to the mating VTOL airframe 4. In the illustrated embodiment, the modular payload airframe section is shaped as a nose-cone, and when affixed to the VTOL airframe 4 defines the aircraft's nose-cone. In particular, the modular payload airframe section tapers to an apex at a first end defining the nose-cone, and is configured with the releasable fixations means at a second end located opposite the first end.

The nose-cone may be at least partially hollow, such that a storage volume may be formed at least partly within it. This enables a payload to be stored therein.

The exemplary VTOL aircraft frame 4 is shown for illustrative purposes only, and it is to be appreciated that the modular payload airframe section 1 could be affixed to any type of airframe, and is not restricted for use with VTOL type aircraft. In this regard the illustrated VTOL aircraft airframe 4 is not to be construed as limiting. The illustrated VTOL airframe 4 comprises a main fuselage, a right and left main wing section, and a horizontal stabilizer and a vertical stabilizer. Mounted to each wing are two lift rotor housings, which are each arranged to house a lift rotor, which in operation generate the lift required for vertical take-off. The VTOL aircraft airframe 4 may also be arranged to comprise one or more forward thrusters (not shown) which drive the aircraft in a forwards direction.

The main payload section 2 may be stored and positioned for attachment, initially loaded and or unloaded, and/or otherwise secured while not attached to the VTOL airframe 4 via a transfer cradle frame (not shown). The transfer cradle frame (not shown) may be moved about via any known power-assisted cargo moving device, tractor or pusher, or lifted via conventional fork truck or similar cargo moving vehicle, including mobile or overhead cranes.

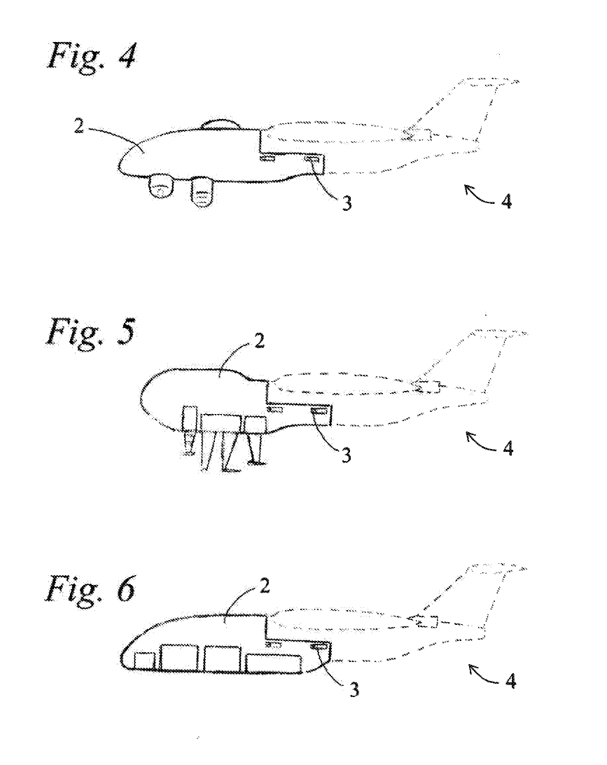

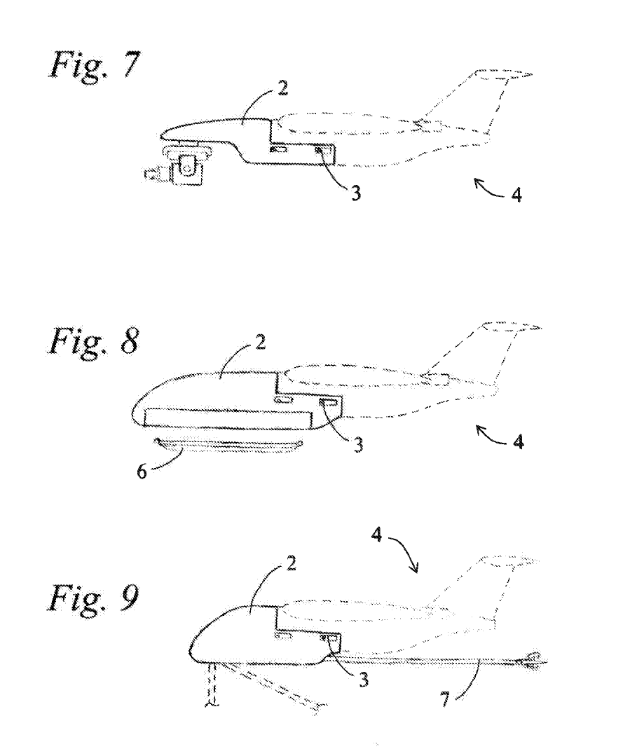

The payload section 2 may be provided with a plethora of different functionalities to fulfill various different mission specifications. Non-limiting examples of these encapsulated mission specific payloads and or designed functions include: fuel tank expansion as shown in FIG. 9, whereby a refueling wand 7 may be retractable and or repositionable in order to accommodate many methods of refueling or fuel delivery; Intelligence, Surveillance, and Reconnaissance (ISR) mission equipment (depicted in FIG. 4); Communication Array Expansion (including temporary aerial relaying stations) such as shown in FIG. 5, and Swarming Aircraft Intranet Enhancement; Rapid Situational Awareness and Assessment via Tracking, HiR/IR Video, LiDAR equipment and the like; Coordinated Relay and Tagging Operations for military, border patrol, coast guard, police, air rescue, disaster relief and other humanitarian efforts; Aerial Mine Detection; Forest Fire Monitoring as well as added action; Maritime Security including oil rig and anti-piracy; Actual injured personnel stretcher 6 transport (FIG. 8); also Agricultural assessment and fertilizer/treatment applications; Major de-icing operations and other chemical down-spray applications, just to name a few specific examples of the module flexibility and functionality that can be had from one major airframe with such interchangeable payload modules. FIGS. 4 through 9 depict a few of the envisaged, but by no means complete list of specific payload section configurations.

The payload fuselage section 2 may be stored, transported in, and moved about via an associated transfer cradle frame (not shown) onsite, when not affixed to a complementary VTOL airframe. For initial loading and or alternate transfers it is envisaged that skyhook lifting points may be used, to enable the payload fuselage section 2 to be moved between different transfer cradle frames, and or moved directly to a receiving or host VTOL airframe 4 for fixation. Different payload fuselage section models may be designed for fixation to different airframe types.

The payload fuselage section 2 completes the forward/nose-cone section of the host airframe 4, and also serves to enhance slipstream flows. In certain embodiments, the aerodynamic shape of the payload fuselage section 2 is designed to eliminate additional parasitic drag that is associated with typical interchangeable cargo pod type systems or the like.

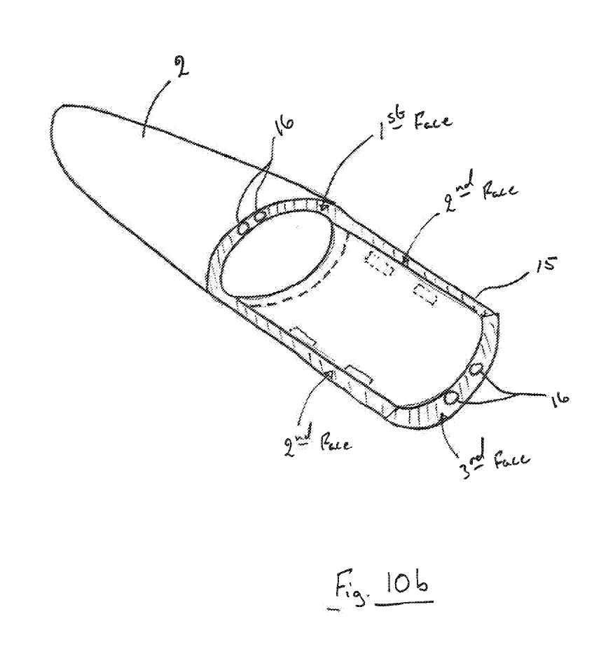

In certain embodiments, the payload fuselage section 2 may comprise alignment connect points provided to facilitate the alignment of the payload fuselage section 2 with the aircraft airframe 4. The alignment may be achieved by specially designed and tapered centering pins 10 that facilitate the initial alignment, as illustrated in FIGS. 11 and 12. In certain embodiments, it is envisaged that the centering pins 10 are provided on the airframe 10 and are received in complimentary shaped cavities located in the payload fuselage section 2. In certain embodiments the pins may be approximately 35 mm in length. Once the pins 10 are engaged in their corresponding cavities then the payload fuselage section 2 may be fixated to the corresponding airframe 4 via fixation means, which fixation means may comprise one or more male members configured for mating with one or more complimentary female members located in the airframe 4. In certain embodiments, the fixation means may comprise several, at least six, latches 3 located in the payload fuselage section 2, and arranged to fasten the payload fuselage section 2 to the aircraft airframe 4.

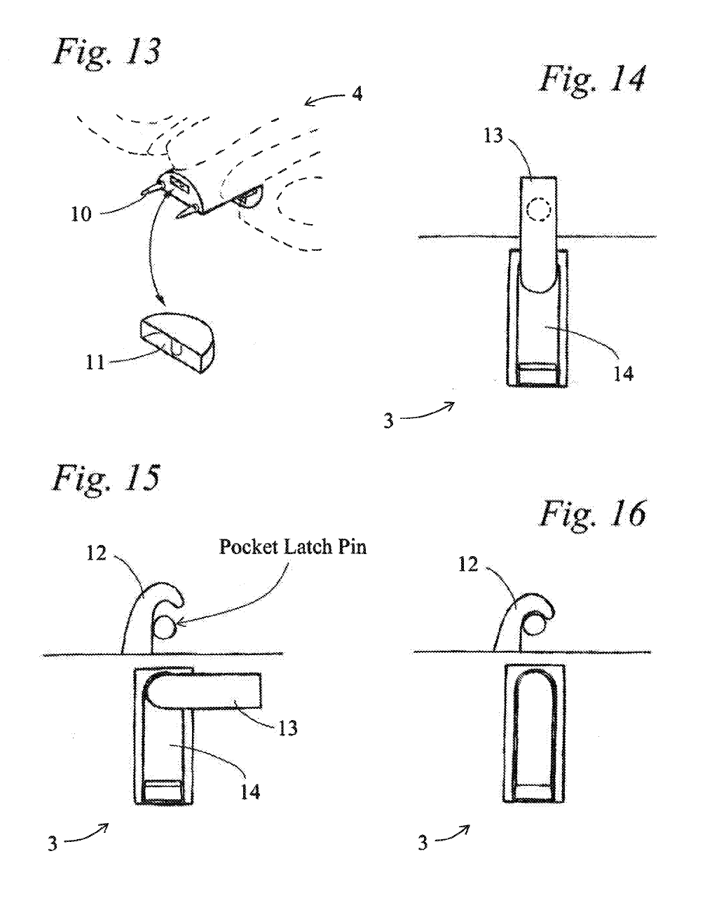

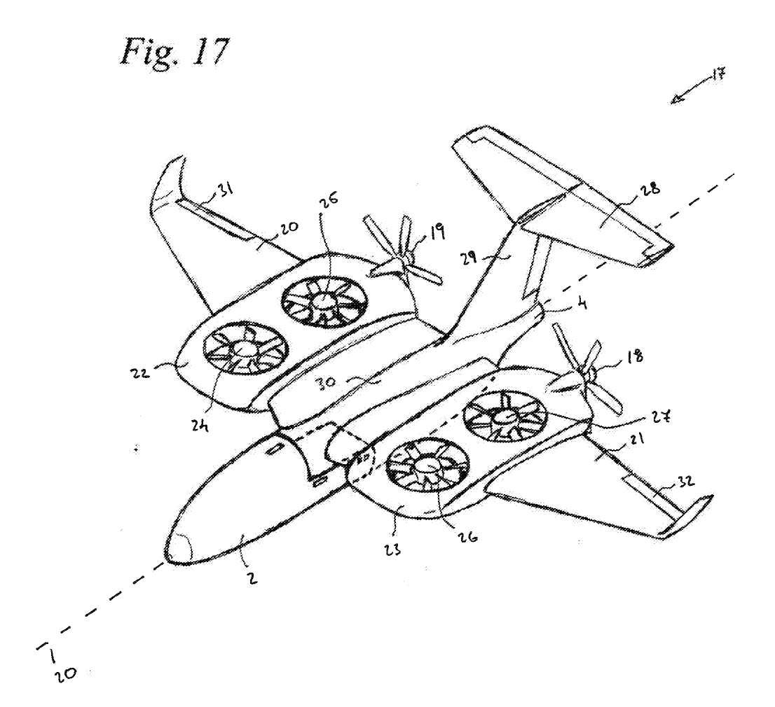

In certain embodiments the alignment pins 10 may be part of the bulkhead structure of the airframe 4 as opposed to only being adhered to the outer shell areas. Furthermore, structural webbing and reinforcement may surround each alignment pin 10 and may even be tied to inner surfaces of the shell for overall optimization of load distribution, and improvement of the rigidity of the alignment pins 10. Once all of the pins 10 are fully engaged in their respective cavities, then the latches 3 are operated turn-cam style to engage load-bearing fingers 12 with receiving pin-pockets 11 located on the aircraft airframe 4. FIG. 13 shows an exploded close-up view of a typical receiving pin pocket 11 for reference. Each latch finger 12 rotates into and engages a counterpart pin-pocket 11 and as the respective turning handle 13 is rotated into the closed position. In the closed position, the turning handle 13 is pushed into a spring retained pocket 14. Once snapped into the retaining pocket 14, the latch handle 3 lies flush or very slightly below the outer surface of the payload fuselage assembly, in order to reduce drag. In certain embodiments, the general sequence for the latching procedure may be: —turn the latch handle 13 a first 90 degrees clockwise to reveal and set the latching finger 12; followed by turning the latch handle 13 again, another 90 degrees clockwise to draw the latch finger 12 and mating fuselage sections tightly together; and finally, pushing the latch handle into the retaining pocket 14 where it is snapped into place for flight. This sequence is depicted in FIGS. 14, 15, and 16.

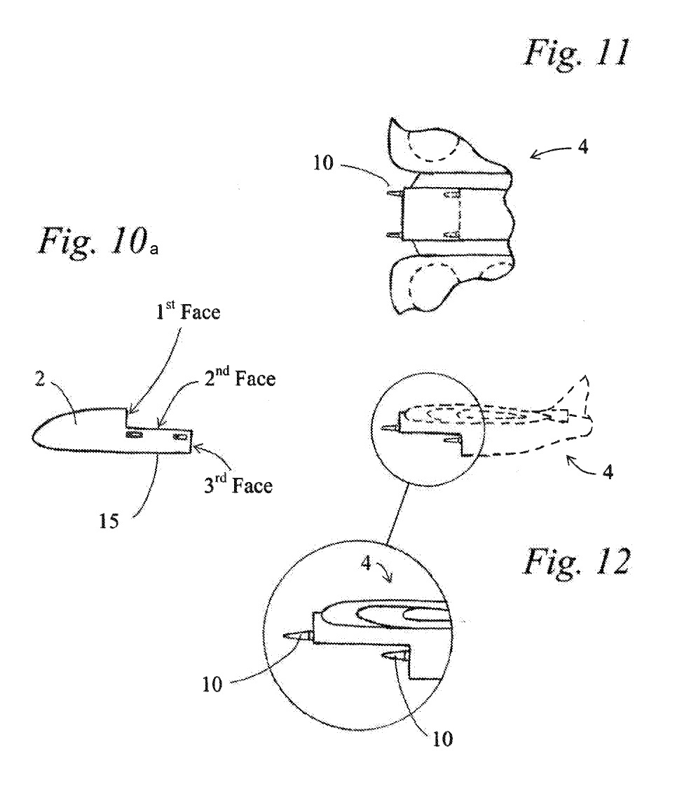

In certain embodiments as illustrated in FIGS. 10a and 10b, the payload fuselage section 2 comprises a projection 15 extending axially from its back end. In the illustrated embodiment, the payload fuselage section 2 is shaped as a nose-cone. In combination with the payload fuselage section 2, the projection 15 forms a stepped profile when viewed in a plane extending parallel to a lengthwise axis of the payload fuselage section 2. The projection is arranged in use to form a lap joint with a complimentary shaped projection extending from the fuselage section of the airframe 4. Examples of this lap joint configuration are illustrated in FIGS. 1, 3, and 4 through 9. This stepped profile results advantageously in at least three different mating faces being formed, which are denoted in FIGS. 10a and 10b, and which help to distribute stress over a greater number of surfaces. An advantage associated with this arrangement is that the robustness of each mating area of the main airframe 4 and the payload module 2 is improved. This geometric configuration also results in a more structurally integrated configuration of the payload module 2 and airframe 4 with their respective fuselage sections. This geometric configuration also affords three separated points and two separated directional vectors of force retention. At least four equally spaced (on their respective mating connecting face) upwards oriented latching fingers 12 that secure the payload module 2 in the vertical axis direction of the overall aircraft (hanging load), and at least two other centrally positioned horizontally oriented latching fingers 12 to secure the payload module in the longitudinal axis direction of the aircraft.

In the certain embodiments as illustrated in the FIGS. 1, 3 and 4 through 9, the projection 15 is arranged in use to form the lap joint by underlying the complementary shaped projection extending from the fuselage section of the aircraft airframe 4.

In some embodiments, the projection 15 may be reserved for standard fuel cell clearances and may also retain the primary vertically oriented load carrying latch fingers 12. In addition, it may also be utilized as extra space for specific useful loads that may require the additional length provided in this volumetric area.

In certain embodiments, one or more alignment pin cavities 16 may be comprised in the projection, each pin cavity being dimensioned to receive a complimentary pin 10 comprised on the airframe 4. This is illustrated in FIG. 10b.

This combination of offset face and multiple stage alignment pins 10, in combination with the perpendicularly oriented latching finger assemblies 12 allows the remaining geometrically symmetrical forward portion of the payload module 2 fuselage to be most open and available to be best utilized for payload cargo. The resulting geometric shape interface also affords a lighter and more rigid mounting structure as opposed to two flat surfaces.

FIG. 17 illustrates a VTOL aircraft 17 comprising the modular payload airframe section 2. The VTOL aircraft comprises two forward thrusters, including a left side thruster 18 and a right side thruster 19. The thrusters drive motion of the VTOL aircraft 17 in a direction parallel to the longitudinal axis 20. The VTOL aircraft comprises an airframe 4 to which the modular payload airframe section 2 is affixed. The VTOL aircraft 17 comprises a right 20 and a left 21 main wing section. Each wing section comprises a lift rotor housing. The right main wing section 20 comprise a right lift rotor housing 22, and the left main wing section 21 comprises a left lift rotor housing 23. The right lift rotor housing 22 encompasses and retains at least two preferably collective pitch lifting roto assemblies 24, 25, and the left lift rotor housing 23 encompasses and retains at least two preferably collective pitch lifting rotor assemblies 26, 27. The aircraft 17 also comprises a fore and/or an aft mounted horizontal stabilizer 28 and a vertical stabilizer 29, or alternatively the horizontal and vertical stabilizers may be replaced with a form of upward or downward facing V-Tail assembly (not shown). The vertical stabilizer 29 may be mounted and extends upward from an aft station location of the fuselage 30 of the aircraft. The horizontal stabilizer 28 may be mounted to the uppermost portion of the vertical stabilizer 29 forming what is largely known in the art as a “T-Tail” assembly comprising of both horizontal and vertical stabilizing and control surfaces. The right 20 and left 21 main wing sections extend from respectively the right and left side of the main aircraft fuselage 30. Although preferably gear-driven propellers, the thrusters 18, 19 may be axial jet engine or turbofan, high-bypass type jet engines. Each wing section 20, 21 may also comprise an aileron, such that the right wing section 20 comprises a right aileron 31, and the left wing section 21 comprises a left aileron 32. Each aileron is attached to its respective wing section and is configured to pivot relative to its respective wing section.

In alternative embodiments of the invention it is envisaged that the modular payload airframe section may comprise a cockpit and navigation controls arranged to accommodate a pilot, and in use enables the pilot to navigate the resulting aircraft.

It will be appreciated by those skilled in the art that the invention has been described by way of example only, and that a variety of alternative embodiments may be adopted without departing from the scope of the invention, as defined by the appended claims. In particular whilst the foregoing embodiments of the invention have been described within the context of use with a VTOL aircraft airframe, it is to be appreciated that the herein described embodiments may be used with any aircraft airframe type.

1. A modular payload airframe section for an aircraft airframe, comprising:
a storage volume for receiving a payload;
a releasable fixation means for releasably affixing the modular payload airframe section to an airframe of the aircraft; and wherein
the modular payload airframe section forms at least part of a nose-cone of the aircraft airframe when affixed thereto.

2. The modular payload airframe section of claim 1, wherein the releasable fixation means comprises one or more male members arranged for engagement with one or more female members comprised in the airframe of the aircraft.

3. The modular payload section of any preceding claim, comprising one or more alignment pin cavities, each cavity being arranged to receive an alignment pin comprised in the aircraft airframe, to facilitate alignment of the modular payload airframe with the aircraft airframe when affixing the modular payload airframe section to the aircraft airframe.

4. The modular payload airframe section of any preceding claim, comprising a hollow nose-cone and wherein the storage volume is formed at least partly within the hollow nose-cone.

5. The modular payload airframe section of claim 4, wherein the modular payload airframe section tapers to an apex at a first end to define the nose-cone, and is configured with the releasable fixation means at a second end located opposite the first end.

6. The modular payload airframe section of claim 5, comprising a projection extending axially from the second end and forming a stepped profile with the nose-cone when viewed in a plane extending parallel to a lengthwise axis of the nose-cone, the projection being arranged in use to form a lap joint with a complementary shaped projection extending from a fuselage section of the aircraft airframe.

7. The modular payload airframe section of claim 6, wherein the projection extending axially from the second end is arranged in use to form the lap joint by underlying the complementary shaped projection extending from the fuselage section of the aircraft airframe.

8. The modular payload airframe section of claim 6 or claim 7, wherein the stepped profile defines three contact surfaces for engagement with the complementary shaped projection extending from the fuselage section of the aircraft airframe.

9. The modular payload airframe section of any one of claims 6 to 8, wherein the projection comprises at least one of the one or more alignment pin cavities.

10. The modular payload airframe section of any preceding claim, wherein the modular payload airframe section is dimensioned to form an aerodynamically smooth junction with the aircraft airframe when affixed thereto.

11. The modular payload airframe section of any preceding claim, comprising a fuel tank engageable with a fuel system of the aircraft airframe.

12. The modular payload airframe section of claim 11, comprising a refueling wand affixed to the exterior of the modular payload airframe section.

13. The modular payload airframe section of any one of claims 1 to 10, comprising a Disaster Relief Module for Medical Transport (DRA-M).

14. The modular payload airframe section of any one of claims 1 to 10, comprising surveillance equipment.

15. The modular payload airframe section of any one of claims 1 to 10 and claim 14, comprising one or more image capture devices.

16. The modular payload airframe section of claim 15, wherein the one or more image capture devices comprise at least one video camera.

17. The modular payload airframe section of claim 15 or 16, wherein the image capture device is configured to image any one or more of the following types of electromagnetic radiation:
a. infrared;
b. ultraviolet;
c. x-rays; and
d. microwaves.

18. The modular payload airframe section of any one of claims 1 to 10 and claims 13 to 17, comprising an aerial relay station.

19. The modular payload airframe section of any one of claims 1 to 10 and claims 13 to 18, comprising a radar module.

20. The modular payload airframe section of any one of claims 1 to 10 and claims 13 to 19, comprising a LIDAR module.

21. The modular payload airframe section of any one of claims 1 to 10 and claims 13 to 20, comprising a chemical dispenser module configured to spray the chemical on underlying terrain in use.

22. The modular payload airframe section of claim 21, wherein the chemical is any one of a fertilizer and a de-icer.

23. The modular payload airframe section of any preceding claim, comprising a cockpit arranged to accommodate a pilot.

24. The modular payload airframe section of any preceding claim, wherein the modular payload airframe section is configured for use with a vertical take-off and landing (VTOL) aircraft frame.

25. The modular payload airframe section of claim 24, wherein the VTOL aircraft frame is the airframe of an unmanned aerial vehicle (UAV).

26. An aircraft comprising the modular payload airframe section of any one of claims 1 to 25.

27. The aircraft of claim 26, wherein the aircraft is a vertical take-off and landing (VTOL) aircraft.

28. The aircraft of claim 27, wherein the VTOL aircraft comprises two or more pairs of lift rotors, and one or more axial thrusters.

29. The aircraft of any one of claims 26 to 28, wherein the VTOL aircraft is an unmanned aerial vehicle (UAV).

30. An aircraft fuselage configured to receive the modular payload airframe section of any one of claims 1 to 25.

31. The aircraft fuselage of claim 30, wherein the fuselage is a fuselage of a vertical take-off and landing (VTOL) aircraft.

32. A method of forming an airframe of an aircraft, the method comprising:
providing a main fuselage section representing a portion of an aircraft fuselage;
providing a modular payload airframe section having a storage volume for receiving a payload;
bringing the main fuselage section and the modular payload airframe section together at a mutual interface; and
releasably locking the two sections securely, such that the modular payload airframe section forms at least part of a nose-cone of the aircraft airframe.
